(19) United States
(12) Patent Application Publication
(10) Pub. No.: US 2022/0414754 A1
(43) Pub. Date: Dec. 29, 2022

(54) SYSTEMS AND METHODS FOR GENERATING PERSONALIZED CONTENT ITEMS

(71) Applicant: Meta Platforms, Inc., Menlo Park, CA (US)

(72) Inventor: Jaleh Afshar, Menlo Park, CA (US)

(21) Appl. No.: 17/362,703

(22) Filed: Jun. 29, 2021

(51) Int. Cl. G06Q 30/06; G06N 20/00; G06Q 30/02

(52) U.S. Cl. CPC G06Q 30/0643; G06N 20/00; G06Q 30/0631; G06Q 30/0271

(57) ABSTRACT

Systems, methods, and non-transitory computer-readable media can be configured to determine a content item template that includes a placeholder character. A personalized character can be generated based on the placeholder character and user preference information of a user. A personalized content item can be generated for the user based on the content item template and the personalized character.

### FIELD OF THE INVENTION

The present technology relates to automated content generation. More particularly, the present technology relates to generating personalized content in a network environment.

### BACKGROUND

Today, people often utilize computing devices (or systems) for a wide variety of purposes. For example, users can utilize computing devices to access a social networking system or other type of content or communication platform. The users can utilize the computing devices to interact with one another, share content items, and view content items via the platform. In some instances, a user may post content to a communication platform. Content posted to the communication platform may include text content items and media content items, such as audio, images, and videos. The posted content may be published to the communication platform and accessed by other users.

### SUMMARY

Various embodiments of the present technology can include systems, methods, and non-transitory computer readable media configured to determine a content item template that includes a placeholder character. A personalized character can be generated based on the placeholder character and user preference information of a user. A personalized content item can be generated for the user based on the content item template and the personalized character.

In an embodiment, the user preference information is based on engagement information associated with the user and the engagement information indicates at least one of: a content item with which the user interacted, a type of interaction, or an amount of time associated with an interaction.

In an embodiment, the generating the personalized character is further based on parameters associated with the content item template, wherein the parameters specify at least one of: a value or a range associated with an appearance characteristic.

In an embodiment, appearance characteristics associated with the personalized character are maintained for a specified period of time.

In an embodiment, the user preference information is determined based on a machine learning model.

In an embodiment, the machine learning model can be trained based on training data that includes user features associated with users and content features associated with content items with which the users interact.

In an embodiment, the content features include appearance characteristics of people appearing in the content items.

In an embodiment, the machine learning model can be refined based on engagement information associated with the user.

In an embodiment, the machine learning model generates a score associated with an appearance characteristic and the score indicates a likelihood the user has a preference for the appearance characteristic over another appearance characteristic.

In an embodiment, the user preference information includes preferences for appearance characteristics and the appearance characteristics include at least one of: hair color, hair style, facial features, facial expression, facial accessories, age, gender, body type, and body pose.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including a personalized content module, according to an embodiment of the present technology.

FIG. 2 illustrates an example functional block diagram, according to an embodiment of the present technology.

FIG. 3A-3B illustrate example interfaces, according to an embodiment of the present technology.

FIGS. 4A-4D illustrate example scenarios, according to an embodiment of the present technology.

FIG. 5 illustrates an example method, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Today, people often utilize computing devices (or systems) for a wide variety of purposes. For example, users can utilize computing devices to access a social networking system or other type of content or communication platform. The users can utilize the computing devices to interact with one another, share content items, and view content items via the platform. In some instances, a user may post content to a communication platform. Content posted to the communication platform may include text content items and media content items, such as audio, images, and videos. The posted content may be published to the communication platform and accessed by other users.

An entity (e.g., company, business, organization) can utilize a communication platform to engage users through content items, such as advertisements. The entity can upload advertisements to the communication platform and deliver the advertisements to users via the communication platform. An important priority is to deliver advertisements that are interesting. In a conventional advertising campaign, the same advertisements are delivered to users. However, an advertisement that appeals to some users may not appeal to other users. Thus, delivering the same advertisements in a campaign often fails to account for individual preferences and accordingly can undermine the overall efficacy of the campaign. Similar problems can arise for users who want to share content with other users. For example, a user can adopt an image as an avatar to represent the user on a communication platform. The user can interact with other users with the avatar. However, while some users may have a positive reaction to the avatar, other users may not. Conventional approaches arising in the realm of computer technology have been ineffective at addressing these problems.

An improved approach rooted in computer technology overcomes the foregoing and other disadvantages associated with conventional approaches specifically arising in the realm of computer technology. The present technology provides for generating a personalized content item, such as an advertisement, an avatar, or other type of content item that can be customized for a person or entity. The personalized content item can be based on a content item template. The content item template can include a placeholder character that can be customized to generate a personalized character in the personalized content item for a user. The placeholder character can be personalized based on user preference information associated with the user. The user preference information can indicate preferences relating to, for example, appearance characteristics, such as hair color, hair style, facial features, facial expression, facial accessories, age, gender, body type, body pose, and the like. The placeholder character can be customized to generate personalized characters for different users. A first user that accesses the personalized content item can see or otherwise experience a first personalization of the placeholder character based on user preference information associated with the first user. Likewise, a second user that accesses the personalized content item can experience a second personalization of the placeholder character based on user preference information associated with the second user. In some instances, machine learning techniques can be employed to determine user preference information.

As just one example, an entity can provide a content item template for an advertisement. The content item template can include a placeholder character that represents a person appearing in the advertisement. Based on the content item template, a first personalized content item to be delivered to a first user can be generated. The first personalized content item can include a first personalized character based on the placeholder character. The first personalized character can be customized based on user preference information associated with the first user. For example, the user preference information associated with the first user can indicate that the first user has a preference for brown hair, glasses, and happy facial expressions. The first personalized character accordingly can be customized to have brown hair, glasses, and a smiling facial expression based on the user preference information associated with the first user. Likewise, a second personalized content item to be delivered to a second user can be generated based on the same content item template. The second personalized content item can include a second personalized character based on the placeholder character. The second personalized character can be customized based on user preference information associated with the second user. For example, the user preference information associated with the second user can indicate that the second user has a preference for blonde hair, earrings, and laughing facial expressions. The second personalized character accordingly can be customized to have blonde hair, earrings, and a laughing facial expression based on the user preference information associated with the second user. More details relating to the present technology are provided below.

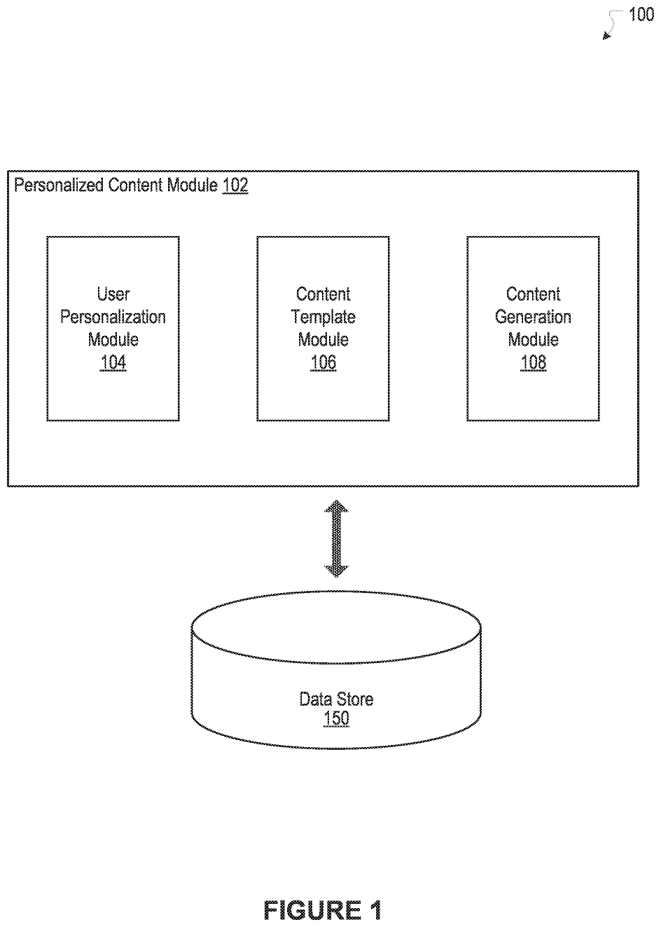

FIG. 1 illustrates an example system 100 including a personalized content module 102, according to an embodiment of the present technology. As shown in the example of FIG. 1, the personalized content module 102 can include a user personalization module 104, a content template module 106, and a content generation module 108. In some instances, the example system 100 can include at least one data store 150 in communication with the personalized content module 102. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the user personalization module 104, the content template module 106, and the content generation module 108 can be implemented in any suitable combinations. While the personalized content module 102 is sometimes herein discussed in connection with a social networking system for purposes of illustration, the personalized content module 102 of the present technology can be used in or for any other type of content or communication platform that can support content delivery, such as a content delivery platform, a communication platform, etc. For example, the personalized content module 102 can be implemented in a suitable server system, such as a content delivery server. In addition, while the personalized content module 102 is sometimes discussed for purposes of illustration in relation to an advertisement, the personalized content module 102 can also apply to avatars and any other types of content items that are customizable.

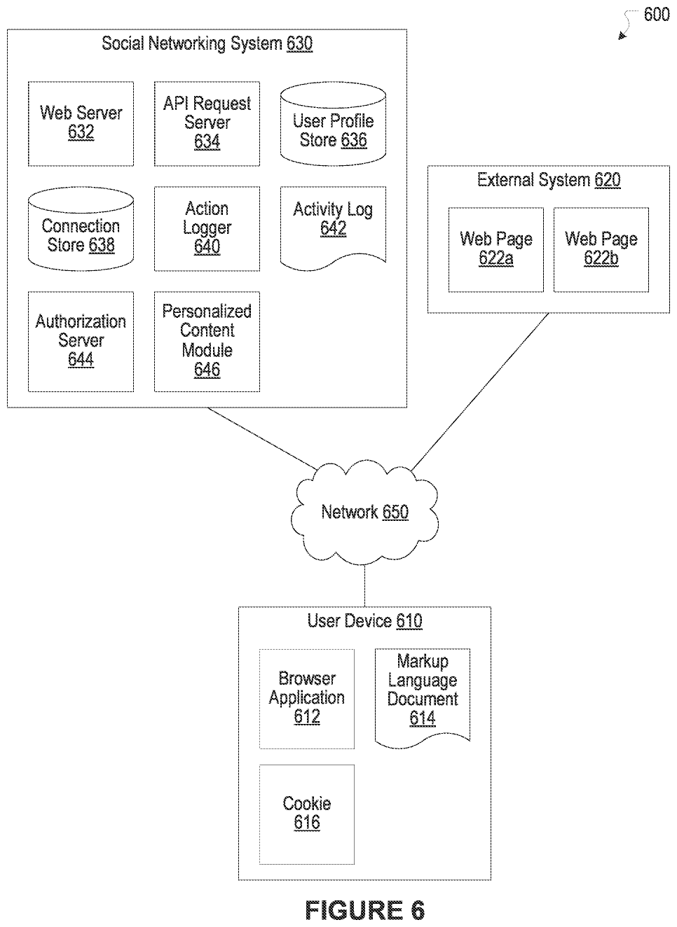

In various embodiments, the personalized content module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some instances, the personalized content module 102 can be, in part or in whole, implemented as software running on one or more computing devices or systems, such as on a server system or a client computing device. In some instances, the personalized content module 102 can be, in part or in whole, implemented within or configured to operate in conjunction with or be integrated with a social networking system (or service), such as a social networking system 630 of FIG. 6. Likewise, in some instances, the personalized content module 102 can be, in part or in whole, implemented within or configured to operate in conjunction with or be integrated with a client computing device, such as the user device 610 of FIG. 6. For example, the personalized content module 102 can be implemented as or within a dedicated application (e.g., app), a program, or an applet running on a user computing device or client computing system. The application incorporating or implementing instructions for performing functionality of the personalized content module 102 can be created by a developer. The application can be provided to or maintained in a repository. In some instances, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The personalized content module 102 can be configured to communicate and/or operate with the data store 150, as shown in the example system 100. The data store 150 can be configured to store and maintain various types of data. In some implementations, the data store 150 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 150 can store information that is utilized by the personalized content module 102. For example, the data store 150 can store information associated with user preferences, content item templates, placeholder characters, personalized characters, and personalized content items. It is contemplated that there can be many variations or other possibilities.

In various embodiments, the user personalization module 104 can determine user preference information associated with a user. The user preference information can be indicative or suggestive of types of content that a particular user may find interesting or appealing. The user preference information can include, for example, preferences for appearance characteristics of persons who appear in content. The appearance characteristics can include, for example, hair color, hair style, facial features, facial expression, facial accessories, age, gender, body type, and body pose. The user personalization module 104 can determine user preference information based on engagement information associated with a user. The engagement information can include information related to content items with which the user interacted and how the user interacted with the content items. Information related to how the user interacted with the content item can include, for example, a type of interaction (e.g., view, click, share, save, other type of conversion) and an amount of time associated with the interaction (e.g., amount of time the content item was viewed, amount of time before the content item was clicked). Based on engagement information associated with a user, preferences for appearance characteristics can be determined for the user. In some cases, the preferences for appearance characteristics can be associated with a context (e.g., product, season, geographical location), as discussed in more detail below. For example, engagement information can indicate that a user interacts with content items related to gyms that include people with certain appearance characteristics such as muscular body type. The engagement information can also indicate that the user interacts with content items related to skin care that include people with certain appearance characteristics such as dark skin tone. Based on the engagement information, user preference information can be determined for the user. In this example, the user preference information can include preferences for a muscular body type in relation to physical fitness and preferences for a certain skin tone in relation to beauty products. Many variations are possible.

In some cases, the user personalization module 104 can determine user preference information based on machine learning methodologies. The user personalization module 104 can train a machine learning model to determine preferences for appearance characteristics for a user. The machine learning model can be trained based on training data that, in some cases, are based on engagement information. The engagement information can include information associated with users and content items with which the users interacted. The training data can include, for example, user features associated with the users and content features associated with the content items with which the users have interacted. The user features can include, for example, age, gender, and geographical location associated with the users. In some cases, the user features can include, for example, user interest in topics reflected by the content items with which the users have interacted and user profile information, such as indicated interests and group memberships. The content features can include, for example, appearance characteristics of people who appear in the content items. Positive training data can include content features associated with content items and user features associated with users who interacted with the content items. Negative training data can include content features associated with content items and user features associated with users who did not interact with the content items. For example, some interactions, such as a view that satisfies a threshold period of time, can be associated with positive training data. Some interactions, such as a view that fails to satisfy the threshold period of time, can be associated with negative training data. In an evaluation or prediction phase, the user personalization module 104 can apply a trained machine learning model to determine user preference information for a user based on user features associated with the user. In some embodiments, the machine learning model can be a multi-label classifier that predicts preferences of a user for a set of appearance characteristics. For example, for each appearance characteristic in the set of appearance characteristics, the trained machine learning model can generate a score associated with the appearance characteristic. In some embodiments, the score can indicate a likelihood that the user has a preference for the particular appearance characteristic. For example, a first appearance characteristic with a score that is higher than a score of a second appearance characteristic can indicate a higher likelihood that the user will have a preference for the first appearance characteristic over the second appearance characteristic. Likewise, a first appearance characteristic with a score that is lower than a score of a second appearance characteristic can be associated with a lower likelihood that the user will have a preference for the first appearance characteristic over the second appearance characteristic.

In an example illustrating some of the functionality of the user personalization module 104, a machine learning model can be trained based on positive training data and negative training data. The training data can include data associated with content items and user interactions with the content items. The training data can be determined based on engagement information describing how users have interacted with the content items. For example, the training data can include views, clicks, likes, and shares of the content items by the users. During inference, the trained machine learning model can be utilized to determine preferences for appearance characteristics of a user. The trained machine learning model can be applied to user features associated with the user. The trained machine learning model can generate scores for appearance characteristics associated with likelihoods that the user has preferences for the appearance characteristics. For example, the trained machine learning model can generate a score for brown hair and a score for red hair. The score for brown hair can be higher than the score for red hair, indicating a likelihood the user has a preference for brown hair over red hair. In some cases, user preference information can include a ranking of preferences for appearance characteristics based on scores for the appearance characteristics. For example, the trained machine learning model can generate a score for brown hair, a score for red hair, a score for black hair, and a score for blonde hair. Based on the scores, brown hair can be ranked highest, red hair can be ranked second highest, black hair can be ranked third highest, and blonde hair can be ranked fourth highest. The ranking can indicate that the user has the highest likelihood to have a preference for brown hair, a second highest likelihood to have a preference for red hair, a third highest likelihood to have a preference for black hair, and a fourth highest likelihood to have a preference for blonde hair. Many variations are possible.

The user personalization module 104 can refine a machine learning model over time. As further described herein, personalized content items can be generated based on user preference information associated with a user. The personalized content items can be provided to the user. The personalized content items can be used as training data to refine the machine learning model based on engagement information associated with the user and the personalized content items. Positive training data for refining the machine learning model can include a first personalized content item with which the user interacted. Negative training data for refining the machine learning model can include a second personalized content item with which the user did not interact. For example, a first personalized content item can be generated for a user based on user preference information associated with the user. The first personalized content item can be provided to the user, for example, in a feed accessed by the user. The user can view the first personalized content item and click on the first personalized content item. Based on the view and the click, the first personalized content item can be used as positive training data for refining a machine learning model. In contrast, the user can view a second personalized content item for less than a threshold period of time and refrain from interacting with the second personalized content item. Based on the view for less than the threshold period of time and the lack of interaction, the second personalized content item can be used as negative training data for refining the machine learning model. In some cases, the user personalization model 104 can refine a machine learning model for a particular user. The machine learning model can be refined based on engagement information associated with the particular user. In some embodiments, positive training data associated with content items with which a particular user has interacted can be weighted more heavily than positive training data associated with content items with which other users have interacted. Negative training data associated with content items with which the particular user has not interacted can be weighted more heavily than negative training data associated with content items with which other users have not interacted. Many variations are possible.

In various embodiments, the content template module 106 can determine context associated with a content item template. The context for the content item template can include information that describes, for example, a product, a season, a geographical location, and the like. The context for the content item template can inform parameters related to appearance characteristics for personalizing a placeholder character in the content item template. The content item template can be a media content item (e.g., image, video) that includes the placeholder character. The placeholder character can indicate a position in the content item template where a personalized character can be located. In some cases, a content item template can include specified parameters associated with a personalized character. The specified parameters can relate to constraints selected by a generator of a content item (e.g., advertiser or user) to limit the scope of possible customization of a placeholder character in the content item. The specified parameters can relate to constraints for appearance characteristics for the personalized character. The parameters can specify, for example, a desired or required value or a range of values associated with hair colors, hair styles, facial features, facial expressions, facial accessories, age, gender, body types, body poses, and the like. For example, a parameter relating to an advertisement in which a placeholder character appears can specify that customization of the character is limited to only two facial expressions, such as smiling and laughing, or that customization of the character is limited to only one hair color. As another example, a parameter relating to an advertisement in which a product appears can require that customizations of the product be limited only to certain product colors.

As mentioned above, a context (e.g., product, season, geographical location) associated with a content item template can provide a basis for appropriate personalizations of a placeholder character in a content item generated from the content item template. Context can describe a product appearing in a content item to be personalized. In addition, context can mean a certain time of the year, such a season. For example, a personalized character can be customized with season appropriate accessories based on the time of the year (e.g., visor versus knit hat, jacket versus shirt, etc.). Context can also account for a geographic location of the user. For example, a personalized character can be customized with styles or accessories that are trending in a particular geographic location of the user. User preference information can vary by context. For example, a user can be associated with both a set of user preference information that corresponds with a context and a different set of user preference information that corresponds with a different context.

As an example of the above, a content item template can include a background image and a placeholder character. In this example, the content item template can be for an advertisement for women's glasses. The context associated with the content item template is the women's glasses as a product of the advertisement. The content item template can also include specified parameters, such as a particular range of possible hair colors to potentially customize the placeholder character. A personalized character can be generated based on the context associated with the content item template (e.g., the women's glasses) and the specified parameters (e.g., the particular range of possible hair colors). Many variations are possible.

The content template module 106 can identify one or more people in a media content item on which a content item template is based. The content template module 106 can indicate positions in the content item template to locate a placeholder character based on locations of the people in the media content item. The content template module 106 can identify one or more objects in the media content item and determine context associated with the content item template based on the objects. The identification of people in the media content item or objects in the media content item can be based on, for example, object or facial recognition techniques. In some cases, a media content item can be an advertisement. An object in the media content item can be a product promoted in the media content item.

For example, a content item template can be based on an image that is an advertisement. The image can include a person promoting a product. The person can be recognized in the image and a position of the person in the image can be determined. A placeholder character can be located at the determined position. A personalized character based on the placeholder character can be generated and placed at the determined position. The product promoted in the image can be identified and serve as context associated with the content item template. Many variations are possible.

In various embodiments, the content generation module 108 can generate a personalized content item based on a content item template. The content generation module 108 can personalize a placeholder character in the content item template based on user preference information associated with a user. In some embodiments, the content generation module 108 maps points on a placeholder character to generate personalized components. For example, a face of the placeholder character can include facial points associated with facial features (e.g., hairline, eyes, eyebrows, nose, mouth, ears). A body of the placeholder character can include connection points (e.g., joints) where body components (e.g., arms, shoulders, legs, hips) connect and body points associated with body features (e.g., clothing, tattoos, accessories, skin features). Personalized components can be generated based on user preference information associated with a user. The personalized components can be aligned to the points on the placeholder character to personalize the placeholder character.

For example, personalized content items can be generated for a first user and a second user based on a content item template. The content item template can have a placeholder character. The placeholder character can include facial points associated with where facial features can be placed on the placeholder character to personalize the placeholder character. The placeholder character can also include connection points that facilitate personalizing a pose of the placeholder character. Based on user preference information associated with the first user, personalized components can be generated and aligned to points on the placeholder character. A first personalized content item that includes the placeholder character personalized based on the user preference information associated with the first user can be provided to the first user. For example, the first user can have a preference for blonde hair, glasses, and a standing pose. A first personalized character can be customized based on the user preference information associated with the first user. The first personalized character can have blonde hair placed at facial points corresponding to where hair is located The first personalized character can have glasses placed at facial points corresponding to where eyewear facial accessories are located. The first personalized character can have a standing pose facilitated by connection points. Likewise, based on user preference information associated with the second user, personalized components can be generated and aligned to points on the placeholder character. A second personalized content item that includes the placeholder character personalized based on the user preference information associated with the second user can be provided to the second user. For example, the second user can have a preference for brown hair, sunglasses, and a sitting pose. A second personalized character can be customized based on the user preference information associated with the second user. The second personalized character can have brown hair placed at facial points corresponding to where hair is located The second personalized character can have sunglasses placed at facial points corresponding to where eyewear facial accessories are located. The second personalized character can have a sitting pose facilitated by connection points. Many variations are possible.

In some cases, the content generation module 108 can vary personalization of a placeholder character based on context associated with a content item template. As described herein, the context associated with the content item template can inform parameters related to appearance characteristics for the personalized character. In some cases, the context associated with the content item template can be based on specified parameters for ranges of appearance characteristics. Personalization of a placeholder character can be based on user preference information but constrained to be within the specified parameters that correspond to desired or predetermined ranges of appearance characteristics, as discussed. In some cases, the content generation module 108 can vary personalization of a placeholder character for a user based on previous personalizations of placeholder characters for the user. For example, personalization of a placeholder character for a user can mirror or duplicate earlier personalizations of placeholder characters for the user. As described herein, user preference information on which personalization of a placeholder character can be based can include scores or rankings of preferences for appearance characteristics. The scores or rankings indicate a user preference for one appearance characteristic over another appearance characteristic. Appearance characteristics associated with higher scores or higher rankings are generally used more often than appearance characteristics associated with lower scores or lower rankings. In some embodiments, the content generation module 108 can vary the personalization of the placeholder character such that lower scoring or lower ranking appearance characteristics are occasionally used for a user. This can avoid providing the same characters to the user. In some cases, a personalization of a placeholder character can be maintained for a user for a threshold period of time. For example, a personalization of a placeholder character for a user can be maintained for the user for a duration of an advertising campaign that is associated with a content item template. As another example, a personalization of a placeholder character for a user can be maintained for the user for an hour, a day, a week, or other duration of time. For example, a personalized content item that includes a personalization of a placeholder character can be provided to a user in a feed associated with the user. The personalization of the placeholder character can be based on user preference information associated with the user and include certain appearance characteristics for which the user has the highest ranked or scoring preferences. The user can refresh the feed and the same personalized content item can be provided to the user in the feed. After a duration of time, such as an hour, a new personalized content item can be generated for the user with a new personalization of the placeholder character. The new personalization of the placeholder character can be based on lower ranked appearance characteristics associated with the user. Many variations are possible.

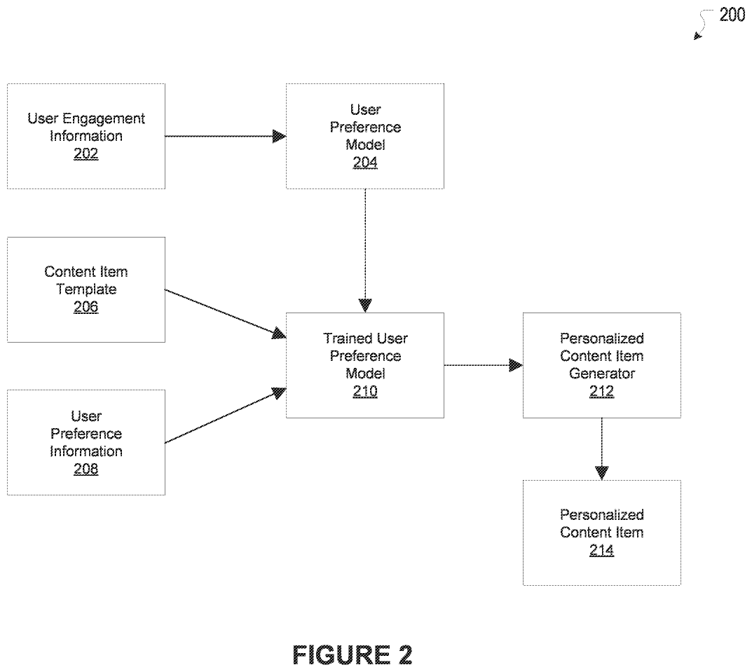

FIG. 2 illustrates an example functional block diagram 200, according to an embodiment of the present technology. The example functional block diagram 200 illustrates an example personalized content item generation process that can be performed or facilitated by the personalized content module 102 of FIG. 1. It should be understood that there can be additional, fewer, or alternative steps performed in similar or alternative orders, or in parallel, based on the various features and embodiments discussed herein unless otherwise stated.

As illustrated in the example functional block diagram 200, user engagement information 202 can be provided to a user preference model 204. Training data for training the user preference model 204 can be based on the user engagement information 202. For example, positive training data can include user features of users and content features associated with content items with which the users have interacted. Negative training data can include user features of users and content features associated with content items with which the users did not interact. In an inference phase, a content item template 206 and user preference information 208 associated with a user can be provided to a trained user preference model 210. In this example, the content item template 206 can include a placeholder character. The trained user preference model 210 can determine a personalization for the placeholder character that is constrained by parameters informed by contexts associated with the content item template 206 and the user preference information 208. The personalization for the placeholder character can be provided to a personalized content item generator 212. The personalized content item generator 212 can apply the personalization to the placeholder character and generate a personalized content item 214 based on the personalization and the content item template 206. All examples herein are provided for illustrative purposes, and there can be many variations and other possibilities.

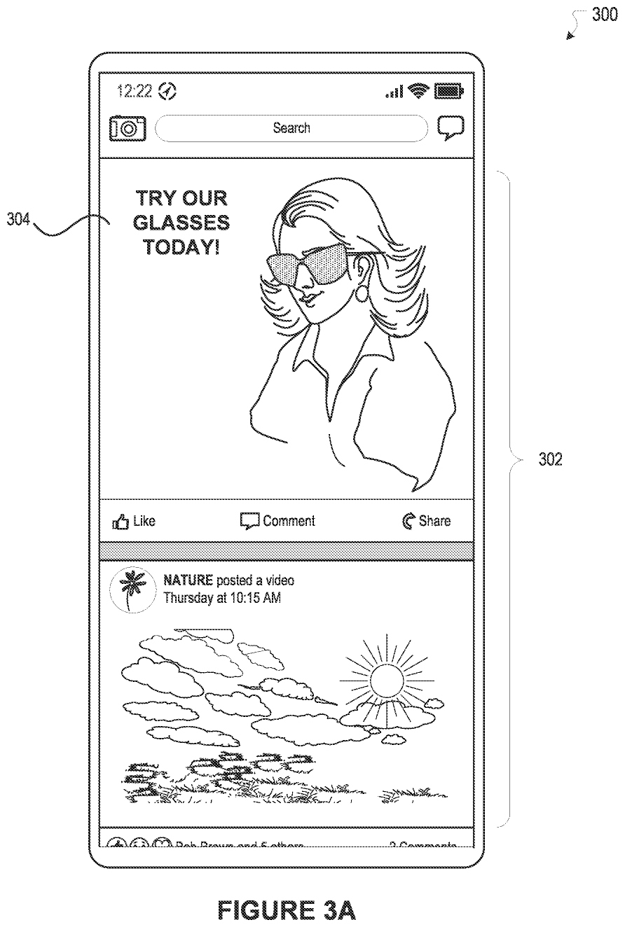

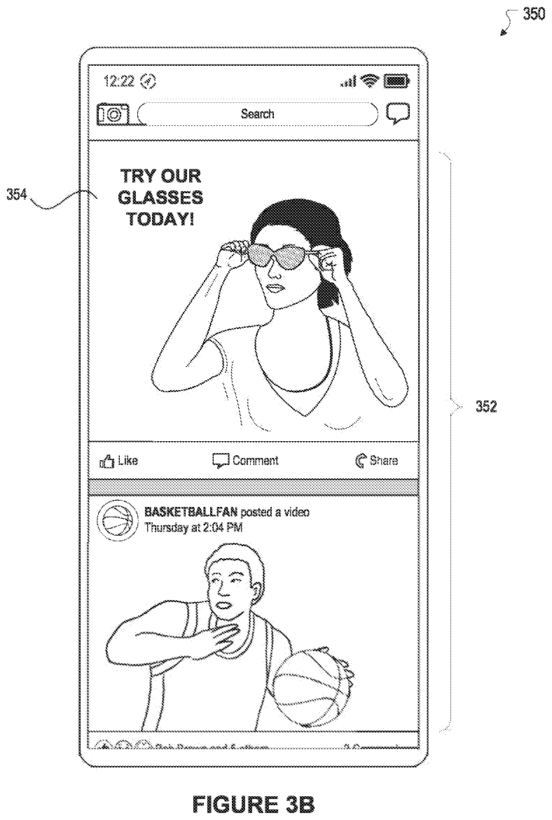

FIGS. 3A-3B illustrate example interfaces associated with generating personalized content items based on the same content item template, according to an embodiment of the present technology. The example interfaces can be generated through a display of a computing system or device. The example interfaces can be associated with one or more functionalities performed by the personalized content module 102 of FIG. 1. It should be understood that there can be additional, fewer, or alternative steps performed in similar or alternative orders, or in parallel, based on the various features and embodiments discussed herein unless otherwise stated. All examples herein are provided for illustrative purposes, and there can be many variations and other possibilities.

FIG. 3A illustrates an example interface 300, according to an embodiment of the present technology. The example interface 300 can be provided, for example, as a user navigates a website or an application associated with a communication platform. The example interface 300 includes a news feed 302. The news feed 302 includes a personalized content item 304. The personalized content item 304 can be generated, for example, as part of an advertisement campaign based on a content item template. For example, the content item template includes a placeholder character. The context associated with the content item template is an advertisement for glasses. A parameter based on the context relates to customization of the placeholder character that includes glasses as a facial accessory. The placeholder character accordingly is to be customized so that the character is depicted with glasses. The placeholder character also can be personalized based on user preference information associated with a first user who has been selected to receive the personalized content item 304. In this example as shown, based on the parameter for the context, the personalized content item 304 includes the placeholder character customized to be shown wearing glasses. Further, the user preference information indicates that the first user has a preference for a particular hair color and a particular facial expression. Accordingly, the personalized content item 304 has been generated to reflect a personalization of the placeholder character that shows the particular hair color and the particular facial expression.

FIG. 3B illustrates an example interface 350, according to an embodiment of the present technology. The example interface 350 can be provided, for example, as a user navigates a website or an application associated with a communication platform. The example interface 350 includes a news feed 352. The news feed 352 includes a personalized content item 354. The personalized content item 354 can be generated, for example, as part of the advertisement campaign of FIG. 3A based on the same content item template in FIG. 3A. A second user has been selected to receive the personalized content item 354. As before, based on the parameter for the context, the personalized content item 354 includes the placeholder character customized to be shown wearing glasses. However, in this example as shown, user preference information indicates that the second user has a preference for a different hair color and a particular body pose. Accordingly, the personalized content item 354 has been generated to reflect a personalization of the placeholder character that shows the different hair color and the particular body pose.

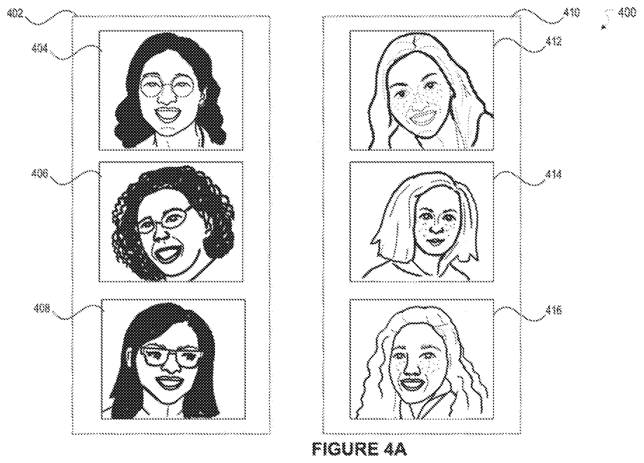

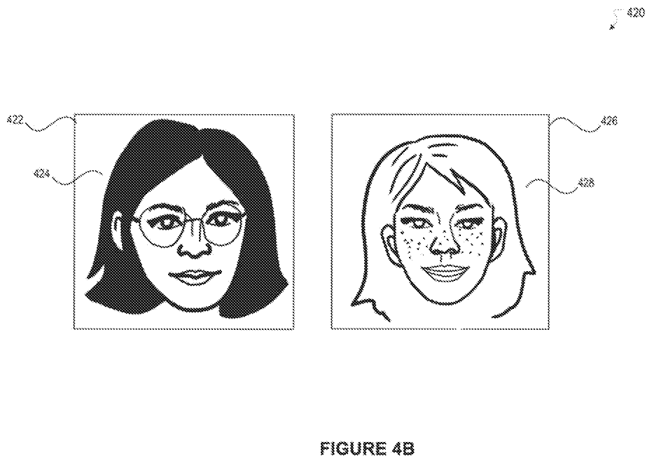

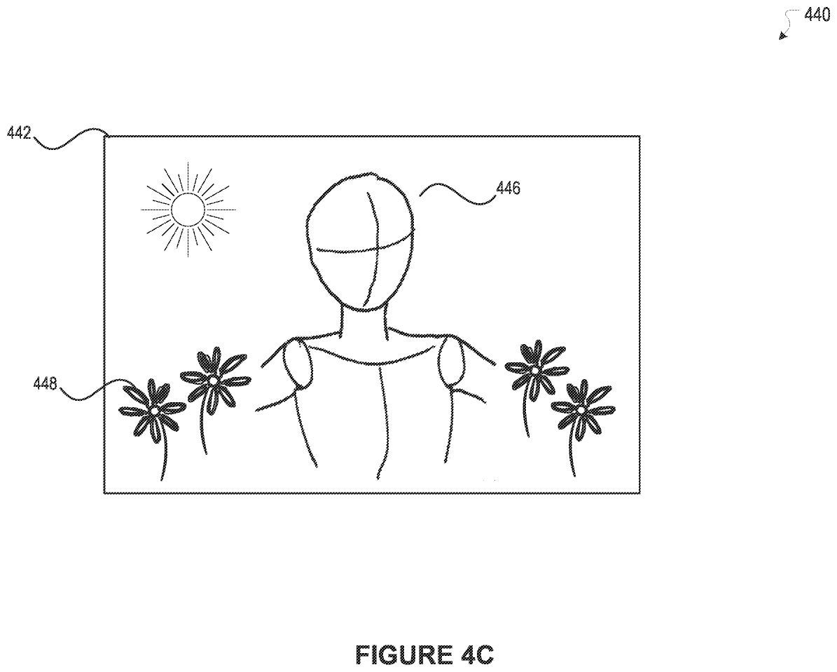

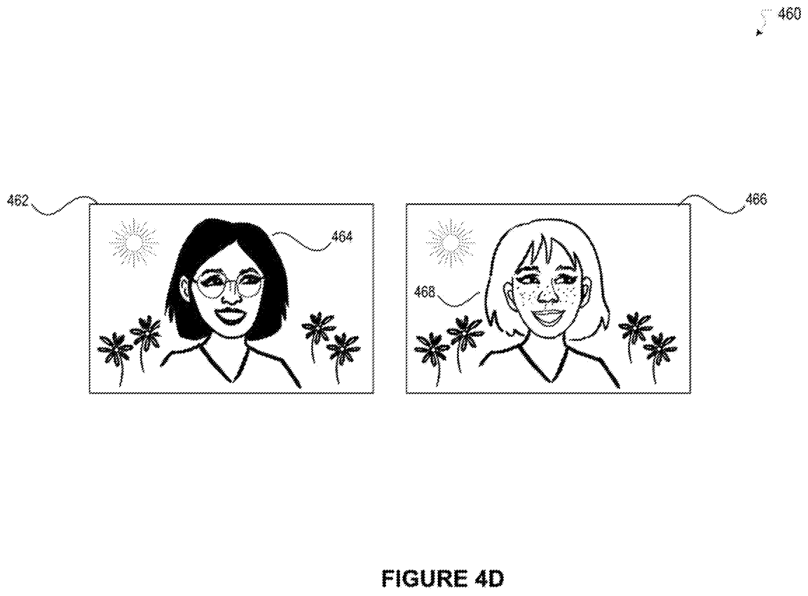

FIGS. 4A-4D illustrate example scenarios associated with generating a personalized content item, according to an embodiment of the present technology. The example scenarios can be associated with one or more functionalities performed by the personalized content module 102 of FIG. 1. It should be understood that there can be additional, fewer, or alternative steps performed in similar or alternative orders, or in parallel, based on the various features and embodiments discussed herein unless otherwise stated. All examples herein are provided for illustrative purposes, and there can be many variations and other possibilities.

FIG. 4A illustrates an example scenario 400, according to an embodiment of the present technology. The example scenario 400 can be associated with determining preferences for appearance characteristics for users. As illustrated in the example scenario 400, engagement information can demonstrate that a first user interacted with a first set of content items that includes a first set of characters 402. The first set of characters 402 includes a first image 404 of a character, a second image 406 of a character, and a third image 408 of a character. The engagement information can also demonstrate that a second user interacted with a second set of content items that includes a second set of characters 410. The second set of characters 410 includes a fourth image 412 of a character, a fifth image 414 of a character, and a sixth image 416 of a character. Based on the engagement information, preferences for appearance characteristics can be determined for the first user and the second user. For example, the first set of characters 402 include characters that have dark hair and wear glasses. The second set of characters 410 include characters that have light hair and have freckles.

FIG. 4B illustrates an example scenario 420, according to an embodiment of the present technology. The example scenario 420 can be associated with user preference information for users that indicate preferences for appearance characteristics of the users. A first example character 422 illustrates first preferred appearance characteristics 424 based on user preference information of a first user. The first user can be, for example, the first user of FIG. 4A. The first preferred appearance characteristics 424 can include, for example, dark hair and glasses. A second character 426 illustrates second preferred appearance characteristics 424 based on user preference information of a second user. The second user can be, for example, the second user of FIG. 4A. The second preferred appearance characteristics 428 can include, for example, light hair and freckles.

FIG. 4C illustrates an example scenario 440, according to an embodiment of the present technology. The example scenario 440 can be associated with generating a personalized content item based on a content item template. As illustrated in the example scenario 440, a content item template 442 includes a placeholder character 446 and a background 448. The placeholder character 446 can be personalized based on user preference information to generate a personalized content item. The personalized content item can include the background 448 and a personalized character in place of the placeholder character 446.

FIG. 4D illustrates an example scenario 460, according to an embodiment of the present technology. The example scenario 460 can be associated with generating a personalized content item based on a content item template. In this example, the content item template is the content item template 442 of FIG. 4C. As illustrated in the example scenario 460, a first personalized content item 462 can be generated for a first user. In this example, the first user is the first user of FIG. 4A and FIG. 4B. The first personalized content item 462 includes a first personalized character 464. The first personalized character 464 is personalized based on user preference information associated with the first user. For example, the user preference information associated with the first user indicate preferences for dark hair and glasses, as discussed. Thus, the first personalized character 464 is personalized to have dark hair and glasses. A second personalized content item 466 can be generated for a second user. In this example, the second user is the second user of FIG. 4A and FIG. 4B. The second personalized content item 466 includes a second personalized character 468. The second personalized character 468 is personalized based on user preference information associated with the second user. For example, the user preference information associated with the second user can indicate preferences for light hair and freckles. In contrast to the first personalized character 464, the second personalized character 468 is personalized to have light hair and freckles.

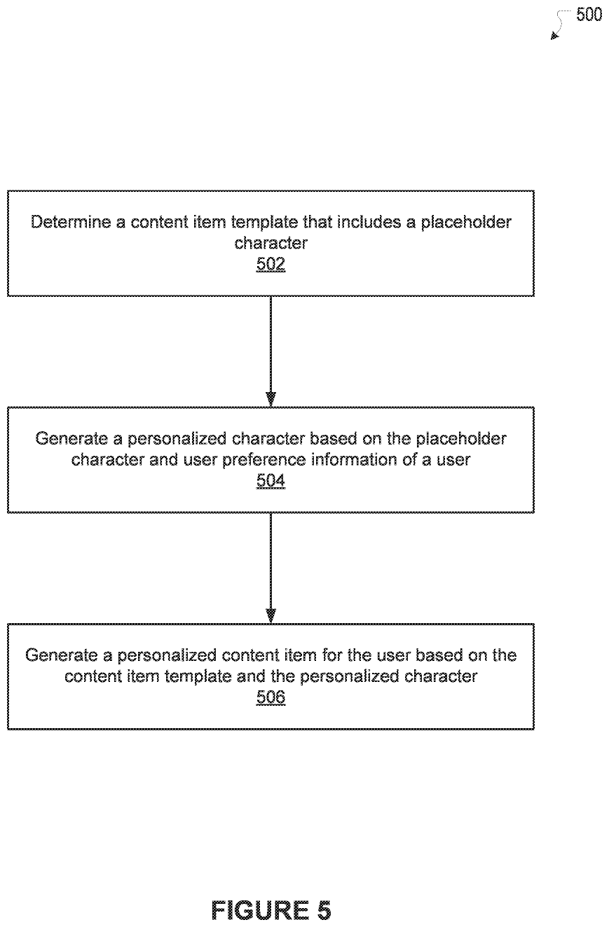

FIG. 5 illustrates an example method 500, according to an embodiment of the present technology. It should be understood that there can be additional, fewer, or alternative steps performed in similar or alternative orders, or in parallel, based on the various features and embodiments discussed herein unless otherwise stated. At block 502, the example method 500 determines a content item template that includes a placeholder character. At block 504, the example method 500 generates a personalized character based on the placeholder character and user preference information of a user. At block 506, the example method 500 generates a personalized content item for the user based on the content item template and the personalized character.

It is contemplated that there can be many other uses, applications, and/or variations associated with the various embodiments of the present technology. For example, in some cases, a user can choose whether or not to opt-in to utilize the present technology. The present technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, according to an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a personalized content module 646. The personalized content module 646 can be implemented with the personalized content module 102, as discussed in more detail herein. In various embodiments, some or all functionality of the personalized content module 102 can be additionally or alternatively implemented by the user device 610. It should be appreciated that there can be many variations or other possibilities.

### Hardware Implementation

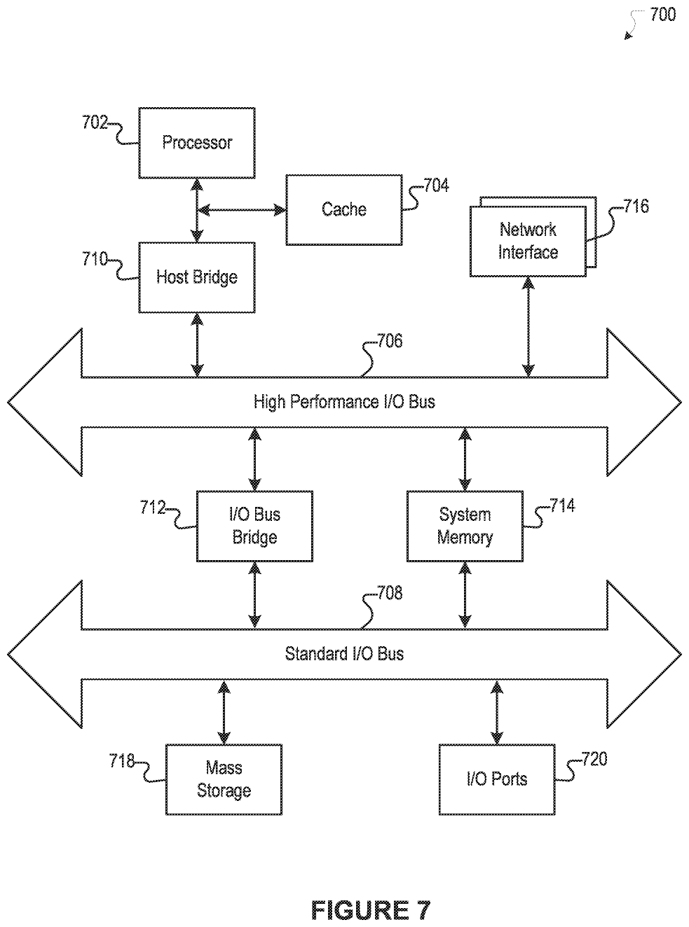

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the present technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
determining, by a computing system, a content item template that includes a placeholder character, wherein the content item template includes a specified range associated with an appearance characteristic associated with the placeholder character;
generating, by the computing system, a personalized character with a personalized appearance characteristic that satisfies the specified range based on the placeholder character and user preference information of a user; and
generating, by the computing system, a personalized content item for the user based on the content item template and the personalized character.

2. The computer-implemented method of claim 1, wherein the user preference information is based on engagement information associated with the user and the engagement information indicates at least one of: a content item with which the user interacted, a type of interaction, or an amount of time associated with an interaction.

3. The computer-implemented method of claim 1, wherein the generating the personalized character is further based on parameters associated with the content item template, wherein the parameters specify a required color to be applied to the personalized character.

4. The computer-implemented method of claim 1, wherein personalized appearance characteristics associated with the personalized character are maintained for a specified period of time.

5. The computer-implemented method of claim 1, wherein the user preference information is determined based on a machine learning model.

6. The computer-implemented method of claim 5, further comprising:
training the machine learning model based on training data that includes user features associated with users and content features associated with content items with which the users interact.

7. The computer-implemented method of claim 6, wherein the content features include appearance characteristics of people appearing in the content items.

8. The computer-implemented method of claim 6, further comprising:
refining the machine learning model based on engagement information associated with the user.

9. The computer-implemented method of claim 5, wherein the machine learning model generates a score associated with an appearance characteristic and the score indicates a likelihood the user has a preference for the appearance characteristic.

10. The computer-implemented method of claim 1, wherein the user preference information includes preferences for appearance characteristics and the appearance characteristics include at least one of: hair color, hair style, facial features, facial expression, facial accessories, age, gender, body type, and body pose.

11. A system comprising:
at least one processor; and
a memory storing instructions that, when executed by the at least one processor, cause the system to perform:
determining a content item template that includes a placeholder character wherein the content item template includes a specified range associated with an appearance characteristic associated with the placeholder character;
generating a personalized character with a personalized appearance characteristic that satisfies the specified range based on the placeholder character and user preference information of a user; and
generating a personalized content item for the user based on the content item template and the personalized character.

12. The system of claim 11, wherein the user preference information is based on engagement information associated with the user and the engagement information indicates at least one of: a content item with which the user interacted, a type of interaction, or an amount of time associated with an interaction.

13. The system of claim 11, wherein the generating the personalized character is further based on parameters associated with the content item template, wherein the parameters specify a required color to be applied to the personalized character.

14. The system of claim 11, wherein personalized appearance characteristics associated with the personalized character are maintained for a specified period of time.

15. The system of claim 11, wherein the user preference information is determined based on a machine learning model.

16. A non-transitory computer-readable storage medium including instructions that, when executed by at least one processor of a computing system, cause the computing system to perform:
determining a content item template that includes a placeholder character, wherein the content item template includes a specified range associated with an appearance characteristic associated with the placeholder character;
generating a personalized character with a personalized appearance characteristic that satisfies the specified range based on the placeholder character and user preference information of a user; and
generating a personalized content item for the user based on the content item template and the personalized character.

17. The non-transitory computer-readable storage medium of claim 16, wherein the user preference information is based on engagement information associated with the user and the engagement information indicates at least one of: a content item with which the user interacted, a type of interaction, or an amount of time associated with an interaction.

18. The non-transitory computer-readable storage medium of claim 16, wherein the generating the personalized character is further based on parameters associated with the content item template, wherein the parameters specify a required color to be applied to the personalized character.

19. The non-transitory computer-readable storage medium of claim 16, wherein personalized appearance characteristics associated with the personalized character are maintained for a specified period of time.

20. The non-transitory computer-readable storage medium of claim 16, wherein the user preference information is determined based on a machine learning model.
